(19) United States
(12) Patent Application Publication
(10) Pub. No.: US 2025/0154887 A1
(43) Pub. Date: May 15, 2025

(54) METHOD FOR POWERING A HEATING DEVICE FOR CATALYTIC CONVERTER

(71) Applicant: Vitesco Technologies GmbH, Regensburg (DE)

(72) Inventors: Nicolas GIRARD, Toulouse (FR); Alexandre SIGAUD, Toulouse (FR)

(21) Appl. No.: 18/695,201

(22) PCT Filed: Sep. 23, 2022
(86) PCT No.: PCT/EP2022/076563

§ 371 Date: Mar. 25, 2024

(30) Foreign Application Priority Data
Sep. 27, 2021 (FR) FR2110129

(51) Int. Cl. F01N 3/20; B60R 16/03

(52) U.S. Cl. CPC F01N 3/2026; B60R 16/03

(57) ABSTRACT

An adaptation module for a motor vehicle with a combustion engine, the vehicle including a power supply module able to supply electric energy and a catalytic converter able to depollute the exhaust gases emitted by the combustion engine and including an electric heating device electrically connected to the power supply module and including a first resistor connected between a high point and a midpoint and a second resistor connected between the midpoint and a low point. The adaptation module being electrically connected firstly to the power supply module and secondly to the high point, the low point, and the midpoint of the heating device, and being configured to adapt the power supplied by the power supply module into an output power and to apply the adapted output power to the heating device.

### CROSS REFERENCE TO RELATED APPLICATIONS

This application is the U.S. National Phase application of PCT International Application No. PCT/EP2022/076563, filed Sep. 23, 2022, which claims priority to French Patent Application No. FR2110129, filed Sep. 27, 2021, the contents of such applications being incorporated by reference herein.

### FIELD OF THE INVENTION

The invention relates to the field of hybrid or combustion-engine motor vehicles, comprising a depolluting device comprising a heating device, and more specifically to an electric power supply method for the heating device.

### BACKGROUND OF THE INVENTION

In a known manner, a combustion-engine or hybrid motor vehicle comprises a catalyst, also called “catalytic converter”, for depolluting the exhaust gases emitted by the combustion engine of the vehicle.

The catalytic converter notably can be an electrically heated catalytic converter, commonly called electrical heated catalyst (EHC). This type of catalytic converter comprises a heating device allowing the temperature in the catalytic converter to be increased rapidly. The heating device notably comprises a resistor.

Still in a known manner, such a vehicle also comprises a battery and an electric machine. The electric machine is able to operate in two operating modes: a drive mode in which the electric machine converts electric energy into mechanical energy in order to start the engine, and a generator mode in which the electric machine converts the mechanical energy from rotation of the engine into electric energy stored in the battery.

Notably, the electric machine and the battery allow the electric network of the vehicle to be powered with electric energy, in order to power various items of vehicle equipment, such as, for example, DC-DC voltage converters or the catalytic converter heating device with DC voltage.

More specifically, the heating device is connected to the electric network via a specific control device configured to connect or disconnect the heating device to or from the electric network.

The state of charge of the battery is variable, for example between 36 V and 52 V, and therefore the voltage supplied by the battery in the electric network also varies. Therefore, when the heating device is powered with electric energy, the power supplied by the heating device also varies. For example, for a heating device comprising a resistor having a value of 0.29 ohm, the power supplied by the heating device may vary between 4400 W and 9200 W. This risks damaging the different components, such as the heating device itself, or the electric network of the vehicle, or the battery.

A first solution involves increasing the value of the resistor of the heating device. However, where the voltage supplied to the heating device is low, notably in the region of 36 V, then the heating device does not receive enough electric energy to work correctly.

In a second solution, a pulse-width modulation device is connected between the control device of the heating device and the heating device. The pulse-width modulation device adapts the voltage supplied by the electric network as a function of the voltage required for the heating device to work correctly. However, this solution generates issues relating to ripple current and electromagnetic compatibility. Furthermore, the pulse-width modulation device can result in premature wear of the battery.

In yet another solution, a DC-DC voltage converter is connected between the electric network and the heating device. The converter can adapt the voltage supplied by the electric network as a function of the voltage required for the heating device to work correctly.

Furthermore, adding a DC-DC voltage converter also requires the addition of a cooling device, which also increases the complexity and cost of the system.

Therefore, there is a need for a solution that makes it possible to overcome these drawbacks at least in part.

### SUMMARY OF THE INVENTION

For this purpose, an aspect of the invention relates to an adaptation module for a motor vehicle with a combustion engine, said vehicle comprising a power supply module able to supply electric energy and a catalytic converter, said catalytic converter being able to depollute the exhaust gases emitted by the combustion engine and comprising an electric heating device, said heating device being electrically connected to the power supply module and comprising a first resistor connected between a high point and a midpoint and a second resistor connected between the midpoint and a low point, the adaptation module being electrically connected firstly to the power supply module and secondly to the high point, the low point, and the midpoint of the heating device, and being characterized in that it is configured to adapt the power supplied by the power supply module into an output power and to apply the adapted output power to the heating device.

The adaptation module can thus instantaneously modify the power supplied by the power supply module of the vehicle to the heating device without making the assembly of the elements in the circuit more complex.

The power supply module preferably comprises a battery and an electric machine.

The adaptation module is preferably configured to adapt the voltage supplied by the power supply module into a finite number of output voltages.

Preferably, a first output power is defined by a first configuration of the adaptation module defined such that:
a. the high point is connected to the power supply module,
b. the low point is connected to ground.

Preferably, a second output power is defined by a second configuration of the adaptation module defined such that:
a. the high point is connected to ground,
b. the midpoint is connected to the power supply module.

Preferably, a third output power is defined by a third configuration of the adaptation module defined such that:
a. the low point is connected secondly to ground,
b. the midpoint is connected to the power supply module.

Advantageously, a fourth output power is defined by a fourth configuration of the adaptation module defined such that:
a. the high point is connected to ground,
b. the low point is connected to ground.

Each configuration advantageously enables an output power specific to that configuration to be supplied. In other words, each configuration of the adaptation module enables the overall resistance value of the heating system to be adapted as a function of the connections of the first resistor and of the second resistor.

According to a first embodiment, the adaptation module comprises:
a. a first relay electrically connected firstly to the high point of the heating device and secondly to ground and to the power supply module, the first relay being configured to connect the high point to ground or to the power supply module,
b. a second relay electronically connected firstly to the midpoint and secondly to the power supply module, the second relay being configured to connect the midpoint to the power supply module and to disconnect the midpoint from the power supply module,
c. a third relay electronically connected firstly to the low point and secondly to ground, the third relay being configured to connect the low point to ground and to disconnect the low point from ground.

Relays are elements that are cheap and simple to implement.

According to a second embodiment, the adaptation module comprises:
a. a first switch connected between the power supply module and the high point,
b. a second switch connected between the power supply module and the midpoint,
c. a third switch connected between the high point and ground,
d. a fourth switch connected between the low point and ground.

The switches are preferably controlled power switches, and notably electronic bipolar switches or MOSFETs.

Electronic switches are elements that are cheap and simple to implement.

An aspect of the invention also relates to a motor vehicle with a combustion engine comprising:
a. a power supply module able to supply electric energy,
b. a catalytic converter able to depollute the exhaust gases emitted by the combustion engine and comprising an electric heating device, said heating device being electrically connected to the power supply module and comprising a first resistor connected between a high point and a midpoint and a second resistor connected between the midpoint and a low point,
c. an adaptation module as disclosed above,
d. a control unit able to control the adaptation module.

An aspect of the invention also relates to a method for supplying power to a heating device of a vehicle as disclosed above, said method comprising the steps of:
a. receiving a request to activate a configuration,
b. disconnecting the heating device from the power supply module,
c. adapting the power supplied by the power supply module to the heating device,
d. reconnecting the heating device to the power supply module.

The power supply method enables the power supplied by the power supply module of the vehicle to the heating device to be modified instantaneously without making the assembly of the elements in the circuit more complex.

### BRIEF DESCRIPTION OF THE DRAWINGS

Other features and advantages of aspects of the invention will become more apparent upon reading the following description. This description is purely illustrative and should be read with reference to the appended drawings, in which:

FIG. 1 illustrates one embodiment of the vehicle according to the invention,

FIG. 2 illustrates the first configuration of the adaptation module according to an aspect of the invention,

FIG. 3 illustrates the second configuration of the adaptation module according to an aspect of the invention,

FIG. 4 illustrates the third configuration of the adaptation module according to an aspect of the invention,

FIG. 5 illustrates the fourth configuration of the adaptation module according to an aspect of the invention,

FIG. 6 illustrates a first embodiment of the adaptation module according to the invention,

FIG. 7 illustrates a second embodiment of the adaptation module according to the invention,

FIG. 8 illustrates one embodiment of the method according to the invention.

### DETAILED DESCRIPTION OF THE PREFERRED EMBODIMENTS

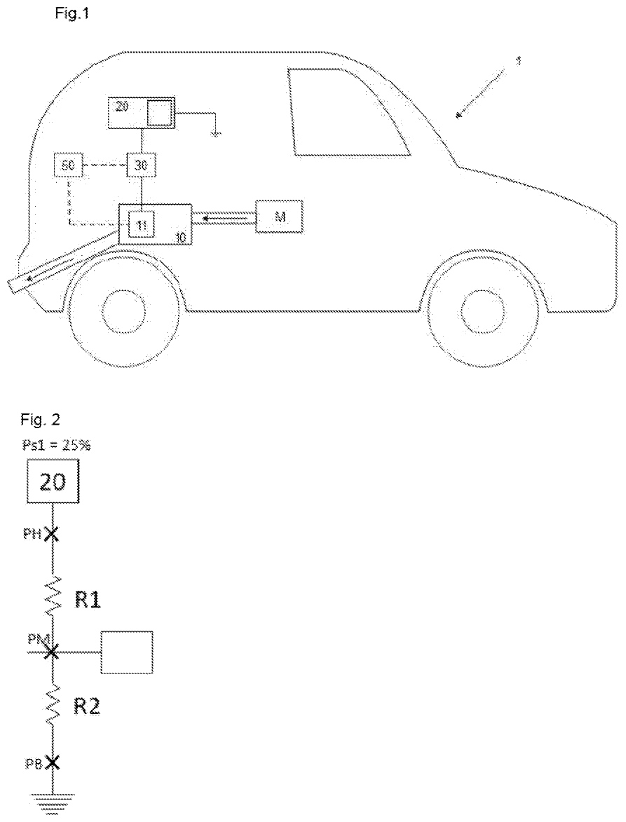

With reference to FIG. 1, an embodiment of a vehicle according to the invention will now be described.

### Vehicle 1

The vehicle 1 is a combustion-engine vehicle or a hybrid vehicle and therefore comprises a combustion engine M.

The vehicle 1 also comprises a catalytic converter 10, a power supply module 20, a power adaptation module 30, and an electronic control unit 50.

The combustion engine M is notably controlled by an engine control computer (not shown in the figures) also installed in the vehicle 1.

The catalytic converter 10 is notably positioned at the outlet of the combustion engine M, and is intended for depolluting the exhaust gases emitted by the combustion engine M, before the exhaust gases are emitted outside the vehicle 1. For example, in the case of a combustion engine M running on diesel, the catalytic converter 10 converts the carbon monoxide and hydrocarbons in the exhaust gases into carbon dioxide and water. In the case of a combustion engine M running on petrol, the catalytic converter 10 converts the carbon monoxide and nitrogen dioxide in the exhaust gases into carbon dioxide.

In addition, the catalytic converter 10 operates correctly at high temperature. Indeed, a high temperature in the catalytic converter 10 allows the chemical reactions that occur in the catalytic converter 10 to be accelerated, in order to quickly and effectively depollute the exhaust gases from the combustion engine M.

To this end, the catalytic converter 10 comprises an electric heating device 11 for heating the inside of the catalytic converter 10. For this reason, this type of catalytic converter 10 also can be called an electrically heated catalyst by a person skilled in the art.

With reference to FIGS. 2 to 5, the heating device 11 comprises a first resistor R1 connected between a high point PH and a midpoint PM and a second resistor R2 connected between the midpoint PM and a low point PB. The first resistor R1 and the second resistor R2 are heating resistors, i.e. resistors that heat up when crossed by an electric current. The first resistor R1 and the second resistor R2 can have the same value or otherwise.

The heating device 11 must therefore be powered with electric energy.

The power supply module 20 is able to supply electric energy, notably to power the heating device 11.

For example, the power supply module 20 comprises a battery and an electric machine.

The battery is electrically connected to the heating device 11.

Furthermore, the battery can operate in a discharging mode in which the battery supplies electric energy, notably to the heating device 11. More specifically, the battery comprises a power branch over which the battery supplies the electric energy. The battery supplies a voltage in the region of +48 V in a known manner.

The battery also comprises a reference branch connected to an electronic reference terminal, in other words to ground.

The electric machine is able to operate in two operating modes: a drive mode in which the electric machine converts electric energy into mechanical energy, and a generator mode in which the electric machine converts the mechanical energy from rotation of the combustion engine M into electric energy stored in the battery.

The electric machine is also connected to the heating device 11 of the catalytic converter 10 and is able to supply electric energy to the heating device 11.

Thus, the heating device 11 is powered either by the electric machine or by the battery of the power supply module 20.

Again with reference to FIG. 1, the adaptation module 30 is electrically between the power supply module 20 and the heating device 11, and more specifically between firstly the power supply module 20 and secondly the high point PH, the low point PB, and the midpoint PM of the heating device 11.

The adaptation module 30 is configured to adapt the power supplied by the power supply module 20 into an output power and to apply the adapted output power to the heating device 11.

More specifically, the adaptation module 30 is configured to adapt the power supplied by the power supply module 20 into a finite number of output powers.

The adaptation module 30 is configured to operate in four configurations, each configuration enabling an output power specific to that configuration to be supplied to the power terminal of the heating device 11.

With reference to FIG. 2, the first configuration provides a first output power value Ps1. According to the first configuration, the high point PH is connected to the power supply module 20 and the low point PB is connected to ground.

In other words, the first resistor R1 and the second resistor R2 are connected in series in the first configuration. Where the value of the first resistor R1 is the same as the value of the second resistor R2, the first output power Ps1 is equal to approximately 25% of the power supplied by the power supply module 20.

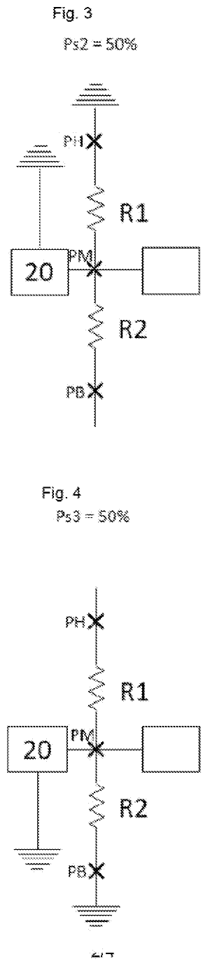

With reference to FIG. 3, the second configuration provides a second power value Ps2. In the second configuration, the high point PH is connected to ground and the midpoint PM is connected to the power supply module 20.

Thus, only the first resistor R1 is connected and usable in the second configuration. Where the value of the first resistor R1 is the same as the value of the second resistor R2, the second output power Ps2 is equal to approximately 50% of the power supplied by the power supply module 20.

With reference to FIG. 4, the third configuration provides a third power value Ps3. In the third configuration, the low point PB is connected to ground and the midpoint PM is connected to the power supply module 20.

Thus, only the second resistor R2 is connected and usable in the third configuration. Where the value of the first resistor R1 is the same as the value of the second resistor R2, the third output power Ps3 is equal to approximately 50% of the power supplied by the power supply module 20.

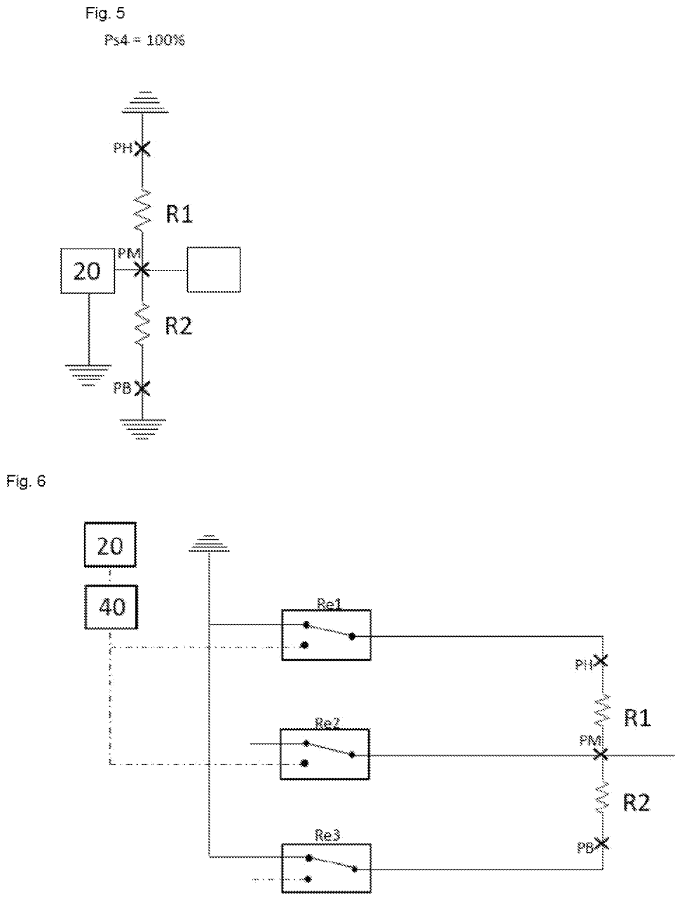

With reference to FIG. 5, the fourth configuration provides a fourth power value Ps4. In the fourth configuration, the high point PH and the low point PB are connected to ground.

In other words, the first resistor R1 and the second resistor R2 are connected in parallel in the fourth configuration. Where the value of the first resistor R1 is the same as the value of the second resistor R2, the first output power Ps4 is approximately equal to the power supplied by the power supply module 20.

FIG. 6 shows a first embodiment of the adaptation module 30 comprising a first relay Re1, a second relay Re2, and a third relay Re3, each comprising three connection terminals.

The first relay Re1 is electronically connected firstly to the high point PH of the heating device 11. The first relay Re1 is also electrically connected to ground and to the power supply module 20. Thus, the first relay Re1 is configured to connect the high point PH to ground or to the power supply module 20.

The second relay Re2 is electronically connected firstly to the midpoint PM. The second relay Re2 is secondly connected to the power supply module 20. Thus, the second relay Re2 is configured to connect the midpoint PM to the power supply module 20 or conversely to disconnect the midpoint PM from the power supply module 20.

The third relay Re3 is electronically connected firstly to the low point PB. The third relay Re3 is secondly connected to ground. Thus, the third relay Re3 is configured to connect the low point PB to ground or conversely to disconnect the low point PB from ground.

When the adaptation module 30 is operating in the first configuration, the first relay Re1 connects the high point PH to the power supply module 20, the second relay Re2 does not connect the power supply module 20 to the midpoint PM, and the third relay Re3 connects ground to the low point PB.

When the adaptation module 30 is operating in the second configuration, the first relay Re1 connects the high point PH to ground, the second relay Re2 connects the power supply module 20 to the midpoint PM, and the third relay Re3 does not connect ground to the low point PB.

When the adaptation module 30 is operating in the third configuration, the first relay Re1 disconnects the high point PH from ground and the power supply module 20, the second relay Re2 connects the power supply module 20 to the midpoint PM, and the third relay Re3 connects ground to the low point PB.

When the adaptation module 30 is operating in the fourth configuration, the first relay Re1 connects the high point PH to ground, the second relay Re2 connects the power supply module 20 to the midpoint PM, and the third relay Re3 connects ground to the low point PB.

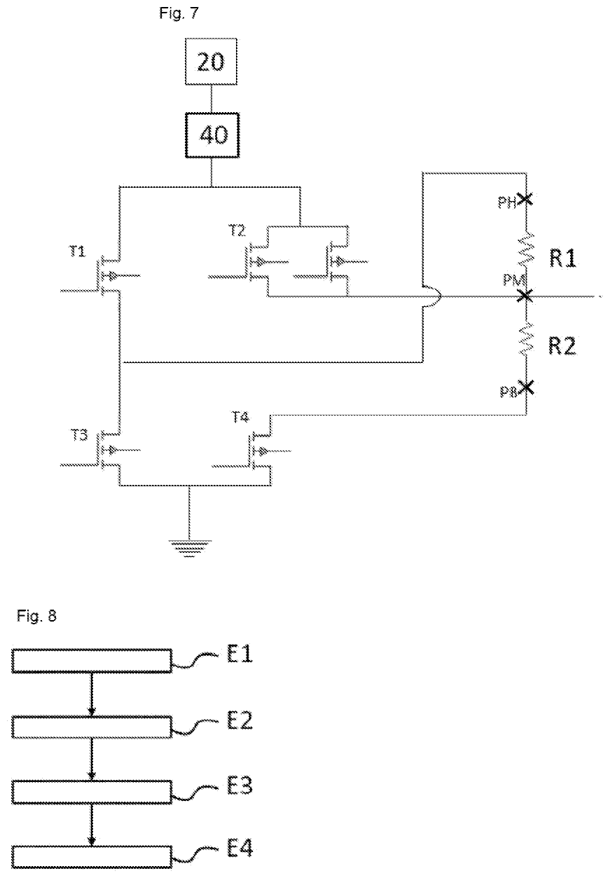

FIG. 7 shows a second embodiment of the adaptation module 30 comprising four switches T1, T2, T3, T4.

The first switch T1 is connected between the power supply module 20 and the high point PH. The second switch T2 is connected between the power supply module 20 and the midpoint PM. The third switch T3 is connected between the high point PH and ground. Finally, the fourth switch T4 is connected between the low point PB and ground.

Each switch is notably a semi-conductor switch, and more specifically a bipolar junction or MOSFET transistor. The second switch T2 comprises two transistors mounted in parallel.

The drain of the first switch T1, of the second switch T2 is connected to the power supply module 20.

The source of the first transistor T1 is connected to the high point PH.

The source of the second switch T2 is connected to the midpoint PM.

The source of the third switch T3 and of the fourth switch T4 is connected to ground. The drain of the third transistor T3 is connected to the high point PH. The drain of the fourth switch T4 is connected to the low point PB.

When the adaptation module 30 is operating in the first configuration, the first switch T1 and the fourth switch T4 are closed, and the other switches are open.

When the adaptation module 30 is operating in the second configuration, the second switch T2 and the third switch T3 are closed, and the other switches are open.

When the adaptation module 30 is operating in the third configuration, the second switch T2 and the fourth switch T4 are closed, and the other switches are open.

When the adaptation module 30 is operating in the fourth configuration, the second switch T2, the third switch T3 and the fourth switch T4 are closed, and the first switch T1 is open.

The adaptation module 30 also comprises a safety switch 40.

According to the first embodiment of the adaptation module 30, the safety switch 40 is connected between the power supply module 20 and the first relay Re1, the second relay Re2.

The safety switch 40 notably comprises one or more transistors, and more specifically one or more MOSFET transistors.

Furthermore, the second embodiment of the adaptation module 30 has two switches in series on each possible path of the current, thereby incorporating an additional safety element that obviates the need to use the safety switch 40, this redundancy being provided by the architecture of the adaptation module 30. Furthermore, in the event of a single switch ceasing to work, certain configurations could still work correctly. For example, if the first switch T1 ceases to work, the second configuration, the third configuration and the fourth configuration can still be used.

The vehicle 1 also comprises a control unit 50 that can control the adaptation module 30, and more specifically activate a configuration of the adaptation module 30.

In other words, the control unit 50 is able to control the first relay Re1, the second relay Re2 and the third relay Re3 in the first embodiment of the adaptation module 30, and the first switch T1, the second switch T2, the third switch T3 and the fourth switch T4 in the second embodiment of the adaptation module 30.

The control unit 50 is also configured to control the safety switch 40, and notably to open or close the safety switch 40.

The vehicle 1 may also comprise an electric network notably used to supply electric energy to the equipment in the vehicle 1. To this end, the electric network comprises at least one electric line installed in the vehicle 1 and electrically connected to the equipment to be powered.

The heating device 11 may be connected to the power supply module 20 via the electric network. In this case, the adaptation module 30 is connected between the electric network and the heating device 11. The voltage is therefore supplied to the adaptation module 30 by the power supply module 20 via the electric network.

### Implementation

With reference to FIG. 8, an embodiment will now be described of the method according to the invention, implemented by the adaptation module 30 and the control unit 50 as described above. The method is described with the battery of the power supply module 20 supplying the electric energy. The method may nonetheless be implemented in the same manner with the electric machine supplying the electric energy.

For example, the method is described with the adaptation module 30 operating, in the initial state, in the first configuration, in which the first resistor R1 is connected in series with the second resistor R2.

The method comprises a step E1 of receiving a request to activate a configuration of the adaptation module 30. For example, during this step, the control unit 50 sends a request to activate the fourth configuration of the adaptation module 30, i.e. a request to increase the power supplied by the adaptation module 30 to 100%.

The method then comprises a step E2 of disconnecting the heating device 11 from the battery. To do so, the safety switch 40 is opened. The opening is commanded by the control unit 50, which sends an open command signal to the safety switch 40.

The method therefore comprises a step E3 of adapting the power supplied by the battery to the heating device 11.

For example, according to the first embodiment of the adaptation module 30, in the initial state, the first relay Re1 connects the high point PH to the battery, the second relay Re2 does not connect the battery to the midpoint PM, and the third relay Re3 connects ground to the low point PB.

The control unit 50 therefore sends a control signal to the first relay Re1 so that the first relay Re1 connects the high point PH to ground (and no longer to the battery) and a command signal to the second relay Re2 to connect the midpoint PM to the battery.

The first relay Re1 thus connects the high point PH to ground, the second relay Re2 connects the battery to the midpoint PM, and the third relay Re3 connects ground to the low point PB.

According to the second embodiment of the adaptation module 30, in the initial state, the first switch T1 and the fourth switch T4 are closed, and the other switches are open. During the adaptation step E3, the processor 50 sends an open command signal to the first switch T1, and a close command signal to the second switch T2 and to the third switch T3.

Thus, the second switch T2, the third switch T3 and the fourth switch T4 are closed, and the first switch T1 is open.

The command signals issued by the processor 50 vary as a function of the configuration of the adaptation module 30 in the initial state and the configuration to be activated, as received by the control unit 50 during the step E1 of receiving a request to activate a configuration.

The method then comprises a step E4 of reconnecting the heating device 11 to the battery. To do so, the safety switch 40 is closed. It is from the closing step E4 that the heating device 11 is powered by the battery and the power supplied by the battery to the heating device 11 has varied from the initial state, switching from 25% to 100% of the power supplied by the battery. The heating power of the heating device 11, and therefore of the first resistor R1 and the second resistor R2, has been adapted.

1. An adaptation module for a motor vehicle with a combustion engine, said vehicle comprising a power supply module able to supply electric energy and a catalytic converter, said catalytic converter being able to depollute the exhaust gases emitted by the combustion engine and comprising an electric heating device, the heating device being electrically connected to the power supply module and comprising a first resistor connected between a high point and a midpoint and a second resistor connected between the midpoint and a low point, the adaptation module being electrically connected firstly to the power supply module and secondly to the high point, the low point, and the midpoint of the heating device, and configured to adapt the power supplied by the power supply module into an output power and to apply the adapted output power to the heating device.

2. The adaptation module as claimed in claim 1, being configured to adapt the voltage supplied by the power supply module (20) into a finite number of output voltages.

3. The adaptation module as claimed in claim 2, in which a first output power is defined by a first configuration defined such that:
a) the high point is connected to the power supply module,
b) the low point is connected to ground.

4. The adaptation module as claimed in claim 1, in which a second output power is defined by a second configuration defined such that:
a) the high point is connected to ground,
b) the midpoint is connected to the power supply module.

5. The adaptation module as claimed in claim 1, in which a third output power is defined by a third configuration defined such that:
a) the low point is connected secondly to ground,
b) the midpoint is connected to the power supply module.

6. The adaptation module as claimed in claim 1, in which a fourth output power is defined by a fourth configuration defined such that:
a) the high point is connected to ground,
b) the low point is connected to ground.

7. The adaptation module as claimed in claim 1, comprising:
a) a first relay electrically connected firstly to the high point of the heating device and secondly to ground and to the power supply module, the first relay being configured to connect the high point to ground or to the power supply module,
b) a second relay electronically connected firstly to the midpoint and secondly to the power supply module, the second relay being configured to connect the midpoint to the power supply module and to disconnect the midpoint from the power supply module,
c) a third relay electronically connected firstly to the low point and secondly to ground, the third relay being configured to connect the low point (PB) to ground and to disconnect the low point from ground.

8. The adaptation module as claimed in claim 1, comprising:
a) a first switch connected between the power supply module and the high point,
b) a second switch connected between the power supply module and the midpoint,
c) a third switch connected between the high point and ground,
d) a fourth switch connected between the low point and ground.

9. A motor vehicle with a combustion engine comprising:
a) a power supply module able to supply electric energy,
b) a catalytic converter able to depollute the exhaust gases emitted by the combustion engine and comprising an electric heating device, said heating device being electrically connected to the power supply module and comprising a first resistor connected between a high point and a midpoint and a second resistor connected between the midpoint and a low point,
c) an adaptation module as claimed in claim 1, and
d) a control unit able to control the adaptation module.

10. A method for supplying power to a heating device of a vehicle as claimed in claim 9, said method comprising:
a) receiving a request to activate a configuration,
b) disconnecting the heating device from the power supply module,
c) adapting the power supplied by the power supply module to the heating device, and
d) reconnecting the heating device to the power supply module.

11. The adaptation module as claimed in claim 2, in which a second output power is defined by a second configuration defined such that:
a) the high point is connected to ground,
b) the midpoint is connected to the power supply module.

12. The adaptation module as claimed in claim 2, in which a third output power is defined by a third configuration defined such that:
a) the low point is connected secondly to ground,
b) the midpoint is connected to the power supply module.

13. The adaptation module as claimed in claim 2, in which a fourth output power is defined by a fourth configuration defined such that:
a) the high point is connected to ground,
b) the low point is connected to ground.
